(19) United States
(12) Patent Application Publication
(10) Pub. No.: US 2008/0298003 A1
(43) Pub. Date: Dec. 4, 2008

(54) Plasma display apparatus

(76) Inventor: Kyung-Rae Pyo, Suwon-si (KR)

Correspondence Address: LEE & MORSE, P.C., 3141 FAIRVIEW PARK DRIVE, SUITE 500, FALLS CHURCH, VA, 22042, US

(21) Appl. No.: 12/153,999

(22) Filed: May 28, 2008

(30) Foreign Application Priority Data
May 31, 2007 (KR) 10-2007-0053417

(51) Int. Cl. G06F 1/16; G09G 3/28

(52) U.S. Cl. 361/681; 345/60

(57) ABSTRACT

A plasma display apparatus includes a front case coupled to a rear case, the front and rear cases facing each other, a plasma display panel between the front and rear cases, and a chassis attached to the front case, the chassis being between the plasma display panel and the rear case, and the chassis including, a base unit parallel to the plasma display panel, at least one flange unit on the front case, the flange being parallel to the base unit and spaced apart from the base unit, and at least one shielding unit connecting the base unit with the flange unit, the shielding unit covering sides of the plasma display panel.

### BACKGROUND OF THE INVENTION

1. Field of the Invention

Embodiments of the present invention relate to a plasma display apparatus. More particularly, embodiments of the present invention relate to a plasma display apparatus having a structure capable of reducing emission of generated electromagnetic waves to an exterior thereof.

2. Description of the Related Art

A plasma display apparatus may include a plasma display panel (PDP) that displays images by a gas discharge. A conventional PDP may include first and second substrates, discharge electrodes between the first and second substrates, and a discharge gas in a plurality of discharge cells between the first and second substrates. Driving signals may be supplied to the discharge gas via the discharge electrodes to generate a discharge between the first and second substrates, so emission of visible light may be triggered to form images.

Generation of discharge, however, may include generation of electromagnetic waves, e.g., when voltage pulses of high frequency and high voltage are applied to the discharge electrodes, between the first and second substrates of the PDP. Emission of the electromagnetic waves outside the plasma display apparatus may be harmful to humans, and may cause electromagnetic interference leading to malfunctioning of external devices.

### SUMMARY OF THE INVENTION

Embodiments of the present invention are therefore directed to a plasma display apparatus, which substantially overcomes one or more of the disadvantages of the related art.

It is therefore a feature of an embodiment of the present invention to provide a plasma display apparatus having a structure capable of reducing emission of generated electromagnetic waves to an exterior thereof.

At least one of the above and other features and advantages of the present invention may be realized by providing a plasma display apparatus, including a plasma display apparatus, including a front case coupled to a rear case, the front and rear cases facing each other, a plasma display panel between the front and rear cases, and a chassis attached to the front case, the chassis being between the plasma display panel and the rear case, and the chassis including, a base unit parallel to the plasma display panel, at least one flange unit on the front case, the flange being parallel to the base unit and spaced apart from the base unit, and at least one shielding unit connecting the base unit with the flange unit, the shielding unit covering sides of the plasma display panel.

The shielding unit of the chassis may be bent with respect to the base unit, and the flange unit of the chassis may be bent with respect to the shielding unit. The front case and the flange unit may have a substantially planar contact surface. The flange unit may surround the base unit of the chassis. The shielding unit may cover all sides of the plasma display panel. The front case and the flange unit may be in direct contact with each other. The plasma display apparatus may further include a conductive gasket between the front case and the flange unit. The conductive gasket may include flexible material. The conductive gasket may include sponge-EMI. The conductive gasket may include a plurality of portions spaced apart from each other along the flange unit. The conductive gasket may be continuous along the flange unit. The plasma display apparatus may further include screws configured to couple the front case, the conductive gasket, and the flange unit.

The plasma display apparatus may further include a conductive tape across the front case and the flange unit. The conductive tape may overlap at least one surface of the flange unit. The front case may include a conductive material. The plasma display apparatus may further include a filter on the plasma display panel, the plasma display panel being between the filter and the chassis. The filter may include an EMI shielding layer. The plasma display apparatus may further include a flexible grounding member between the filter and the front case. The filter may be between the plasma display panel and the front case, the plasma display panel being enclosed by an electromagnetic interference (EMI) shielding loop including at least the filter, the chassis, and the front case. The plasma display apparatus may further include at least one double-sided tape and a thermal conductive medium between the plasma display panel and the base unit of the chassis.

### BRIEF DESCRIPTION OF THE DRAWINGS

The above and other features and advantages of the present invention will become more apparent to those of ordinary skill in the art by describing in detail exemplary embodiments thereof with reference to the attached drawings, in which:

FIG. 1 illustrates an exploded perspective view of a plasma display apparatus according to an embodiment of the present invention;

FIG. 2 illustrates an assembled cross-sectional view of the plasma display apparatus of FIG. 1;

FIG. 3 illustrates a partial enlarged view of a top portion of the plasma display panel of FIG. 2;

FIG. 4 illustrates an exploded perspective view of a plasma display apparatus according to another embodiment of the present invention;

FIG. 5 illustrates an assembled, partial cross-sectional view of a plasma display apparatus according to another embodiment of the present invention; and

FIGS. 6A-6B illustrate graphs of electromagnetic waves emitted from plasma display apparatuses according to embodiments of the present invention.

### DETAILED DESCRIPTION OF THE INVENTION

Korean Patent Application No. 10-2007-0053417, filed on May 31, 2007, in the Korean Intellectual Property Office, and entitled: “Plasma Display Apparatus,” is incorporated by reference herein in its entirety.

Exemplary embodiments of the present invention will now be described more fully hereinafter with reference to the accompanying drawings, in which exemplary embodiments of the invention are illustrated. Aspects of the invention may, however, be embodied in different forms and should not be construed as limited to the embodiments set forth herein. Rather, these embodiments are provided so that this disclosure will be thorough and complete, and will fully convey the scope of the invention to those skilled in the art.

In the figures, the dimensions of elements and regions may be exaggerated for clarity of illustration. It will also be understood that when an element is referred to as being “on” another element or substrate, it can be directly on the other element or substrate, or intervening elements may also be present. Further, it will be understood that the term “on” can indicate solely a vertical arrangement of one element with respect to another element, and may not indicate a vertical orientation, e.g., a horizontal orientation. In addition, it will also be understood that when an element is referred to as being “between” two elements, it can be the only element between the two elements, or one or more intervening elements may also be present. Like reference numerals refer to like elements throughout.

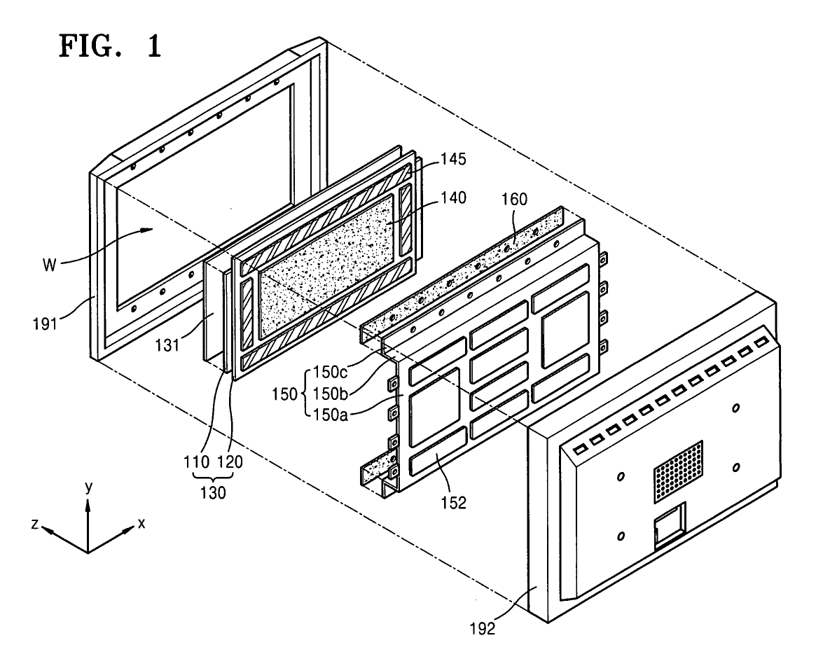

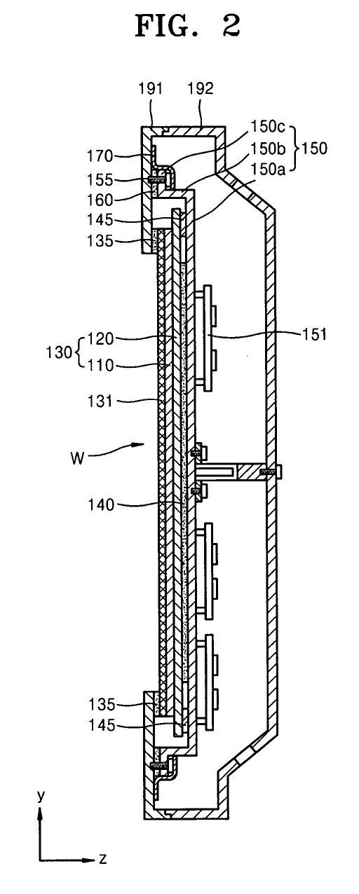

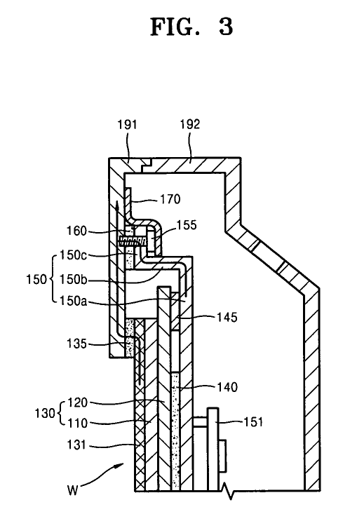

The present invention will now be described more fully with reference to the accompanying drawings in which exemplary embodiments of the invention are illustrated. FIG. 1 illustrates an exploded perspective view of a plasma display apparatus according to an embodiment of the present invention, and FIGS. 2-3 illustrates complete and partial vertical cross-sectional views, respectively, of the plasma display apparatus of FIG. 1. Referring to FIGS. 1-3, a plasma display apparatus may include a plasma display panel (PDP) 130 that displays images and a chassis 150 to support the PDP 130.

More specifically, the PDP 130 may include a first substrate 110 with first and second electrode groups (not shown) disposed alternately, a second substrate 120 attached to the first substrate 110 with the electrode groups therebetween, and a plurality of discharge cells (not shown) arranged, e.g., in a matrix shape, between the first and second substrates 110 and 120. An initiation of a discharge may be induced by applying a predetermined, e.g., alternating current (AC), between the first and second electrodes, so visible light may be emitted from a phosphor material in the discharge cells to form images. Application of the AC between the first and second electrodes may form a time-varying electromagnetic field between the first and second electrodes. The time-varying electromagnetic field may change direction and magnitude consecutively with respect to the AC, and may form a consecutive energy flow emitting electromagnetic waves, i.e., electromagnetic wave interference (EMI). The plasma display apparatus according to embodiments of the present invention may have a substantially reduced emission of the generated EMI to an exterior of the plasma display apparatus, as will be discussed in more detail below.

The chassis 150 of the plasma display apparatus may include a first surface to support the PDP 130, and may include a second surface, i.e., a surface opposite the first surface, to support a plurality of circuit substrates 151 that generate driving signals for driving the PDP 130. The chassis 150 may include a base unit 150a, at least one flange unit 150c, and at least one shielding unit 150b connecting the flange unit 150c to the base unit 150a.

The base unit 150a of the chassis 150 may be a central region of the chassis 150, and may have a substantially planar structure. For example, the base unit 150a may be substantially parallel to the PDP 130, as illustrated in FIGS. 1-3. The base unit 150a may substantially overlap the PDP 130, and may provide the first and second surfaces to support the PDP 130 and the circuit substrates 151, respectively.

The flange unit 150c of the chassis 150 may have a linear structure, and may extend along an edge of the base unit 150a. The flange unit 150c may be positioned in a plane parallel to a plane of the base unit 150a, e.g., in the xy-plane, and may be spaced apart from the base unit 150a, e.g., along the z-axis. More specifically, the flange unit 150c may be between the base unit 150a and the PDP 130, so the flange unit 150c may have a step difference with respect to the base unit 150a, e.g., a space between the flange unit 150c and the base unit 150a along the z-axis. The flange unit 150c may include a substantially planar surface, i.e., a two-dimensional flat surface having a predetermined area along the xy-plane, to provide contact with a front case 191 of the plasma display apparatus along a two-dimensional surface. Accordingly, a contact surface between the flange unit 150c and the front case 191 may have a substantially planar contact surface therebetween.

The shielding unit 150b of the chassis 150 may bridge the step difference between the base unit 150a and the flange unit 150c. In detail, the shielding unit 150b may connect an edge of the base unit 150a to an edge of the flange unit 150 in order to cover sides of the PDP 130. In further detail, the shielding unit 150b may extend over side surfaces of the PDP 130 in, e.g., the xz-plane, so the side surfaces of the PDP in, e.g., the xz-plane, may be shielded by the shielding unit 150c to be entirely separated from an atmosphere exterior to the chassis 150, i.e., medium between the chassis 150 and the rear case 192 and/or medium outside the plasma display apparatus. The shielding unit 150b may or may not be perpendicular to the flange unit 150c. For example, a length of the shielding unit 150b along the z-axis may substantially equal the step difference between the flange unit 150c and the base unit 150a, so the shielding unit 150b may substantially cover side surfaces of the PDP 130.

The shielding unit 150b may function as a shielding wall to prevent or substantially minimize emission of EMI through sides of the PDP 130 to an exterior of the plasma display apparatus. Accordingly, the shielding unit 150b may be formed along one or more of a lower edge of the base unit 150a, an upper edge of the base unit 150a, and/or side edges of the base unit 150a. For example, a plurality of flange units 150c and shielding units 150b may be formed to surround the base unit 150, e.g., a flange unit 150a and a shielding unit 150b may be formed along each one of the four edges of the base unit 150a. As such, a plurality of bending units, i.e., combinations of flange units 150c with shielding units 150b, may be bent from the base unit 150 toward the PDP 130 around a circumference thereof, so all sides of the PDP 130 may be substantially covered, i.e., enclosed between the chassis 150 and the front case 191. For example, the shielding unit 150b may be bent with respect to the base unit 150a, and the flange unit 150c may be bent with respect to the shielding unit 150b, so an EMI shielding envelope may be formed around the PDP 130.

Forming the flange unit 150c to have a substantially planar contact surface, e.g., in the xy-plane, with the front case 191 may be advantageous in ensuring air-tight coupling between the flange unit 150c and the front case 191. As such, adjustment of the contact surface between the flange unit 150c and the front case 191 may facilitate control of the EMI shielding envelope around the PDP 130.

The chassis 150 may be a press-processed metal plate, e.g., formed of aluminum, and may be attached to the front case 191 via the flange unit 150c, so the PDP 130 may be between the chassis 150 and the front case 191. More specifically, the chassis 150 may be screw coupled to the front case 191 by inserting at least one screw member 155 through the flange unit 150c into the front case 191. For additional structural support, a double-sided tape 145, i.e., a tape having a relatively low thermal conductivity, may be interposed along peripheral portions of the second substrate 120 of the PDP 130 to attach to the base unit 150a, as illustrated in FIG. 2. The front case 191 may include a frame structure surrounding a rectangular window W, so images displayed by the PDP 130 may be exposed through the window W. The flange unit 150c of the chassis 150 may be attached to the frame structure of the front case 191. A rear case 192 may be assembled with the front case 191, so the chassis 150 may be therebetween, as further illustrated in FIG. 2.

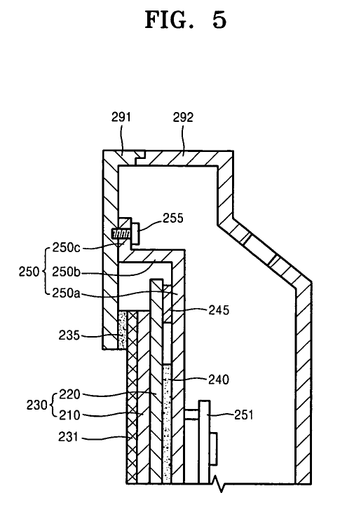

As illustrated in FIG. 5, the flange unit 150c may be attached directly to the front cover 191, so a surface grounding may be formed between the flange unit 150c and the front case 191. Alternatively, as illustrated in FIGS. 1-3, a conductive gasket 160 may be interposed between the flange unit 150c and the front cover 191. The screw members 155 coupled to the front case 191 through the flange unit 150c may provide sufficient coupling force by pressing the conductive gasket 160 against the front case 191, to enhance air-tightness coupling further between the flange unit 150c and the front case 191. The conductive gasket 160 may exhibit flexibility, e.g., to provide close coupling between the chassis 150 and the front case 191, and electrical conductivity, e.g., to block electromagnetic waves. For example, the conductive gasket 160 may be a sponge-EMI having a metal mesh surrounding an external surface of a flexible bulk material.

Thus, the conductive gasket 160 may be interposed between the flange unit 150c and the front case 191 to prevent or substantially minimize generation of gaps between the flange unit 150c and the front case 191. Accordingly, electromagnetic waves captured in the conductive gasket 160 may be drained out of the plasma display apparatus along a common grounding path via the front case 191, as illustrated in FIG. 3.

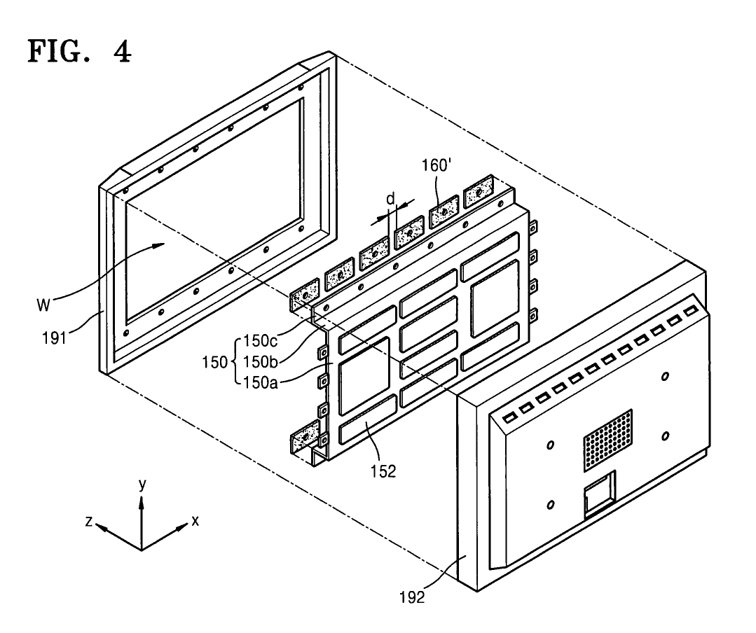

The conductive gasket 160, as illustrated in FIG. 1, may extend continuously between the flange unit 150c and the front case 191. Alternatively, the conductive gasket 160 may include a plurality of discrete portions 160′ spaced apart from each other, as illustrated in FIG. 4. For example, every two adjacent discrete portions 160′ may have a gap d therebetween to completely separate the adjacent discrete portions 160′ from each other. The gaps d may be adjusted with respect to frequency of electromagnetic waves in order to minimize leakage of electromagnetic waves through the gaps d. Thus, a size of the gaps d may be minimized in order to reduce emission of electromagnetic waves having a low frequency band. Accordingly, a choice between a continuous conductive gasket 160 and a plurality of discrete portions 160′ may depend on manufacturing costs and required electromagnetic wave shielding. It is noted that holes formed for the screws 155 through the conductive gasket 160 and/or through the discrete portions 160′ may be sealed by the screws 155 during assembly of the plasma display apparatus and, therefore, are not considered as gaps that interrupt continuity of the conductive gasket 160.

The plasma display panel may further include a conductive tape 170 over a contact region between the chassis 150 and the front case 191, as illustrated in FIG. 3. More specifically, a first end of the conductive tape 170 may be on the shielding unit 150b and a second end, i.e., an end opposite the first end, may extend along a surface of the front cover 191, so the conductive tape 170 may completely overlap at least two surfaces of the flange unit 150c. The conductive tape 170 may function as a prevention film capable of preventing or substantially minimizing emission of electromagnetic waves. Electromagnetic waves captured by the conductive tape 170 may be drained away from the plasma display apparatus along the common grounding path via the front case 191.

The plasma display panel may further include a filter 131. The filter 131 may be on the first substrate 110 of the PDP 130, i.e., between the PDP 130 and the front case 191. Accordingly, the PDP 130 may be enclosed by the filter 131, the chassis 150, and the front case 191. The filter 131 may improve display quality of images displayed on the PDP 130 by optical filtering, and may shield from electromagnetic waves, i.e., EMI, generated in the PDP 130. The filter 131 may attach directly to an image-displaying surface of the PDP 130.

More specifically, the filter 131 may have a multi-layer structure, i.e., a structure including a stack of multiple functional layers capable of performing one or more of shielding/absorbing orange light, improving color function of images with respect to user preference, and/or shielding EMI, directly attached to the PDP by, e.g., using an adhesive. Alternatively, the filter 131 may be a glass filter (not shown) having the plurality of functional layers on a glass material base, so the functional layers may be attached to the PDP via the glass material base. The functional layers of the filter 131 may each individually perform a predetermined function, or at least two of the functional layers may function simultaneously to perform a predetermined function.

For example, the electromagnetic wave shielding function may be performed by connecting a mesh pattern layer, e.g., of a metal component having high conductivity, of the filter 131 to a front case 191 through a grounding member 135, as illustrated in FIG. 2. In this way, an EMI current component, which is transformed by the mesh pattern layer, may be removed from the plasma display apparatus along the common grounding path via the grounding member 135 and front case 191, as illustrated in FIG. 3. The front case 191 may be a portion of the grounding path, and may be formed of a conductive material, e.g., aluminum. The grounding member 135 may be between the front case 191 and the filter 131, and may exhibit flexibility and electrical conductivity. Use of the filter 131 with the electromagnetic wave shielding function in the plasma display apparatus of the present invention may facilitate formation of the EMI shielding envelope around the PDP 130.

The plasma display panel may further include a thermal conductive sheet 140 between the chassis 150 and the PDP 130. The thermal conductive sheet 140 may form a heat radiation path, so heat generated during operation of the PDP 130 may be dissipated through the chassis 150 to the exterior of the plasma display apparatus. The thermal conductive sheet 140 may be disposed on a central portion of the second substrate 120 of the PDP 130, i.e., facing the base unit 150a of the chassis base 150.

As illustrated in the embodiments of FIGS. 1-5, the plasma display apparatus may be advantageous in providing a structure capable of shielding emission of EMI from the PDP 130. The EMI shielding structure includes the filter 131 and the base unit 150a of the chassis 150, which may be respectively disposed in front of and behind the PDP 130, so the shielding unit 150b, the conductive gasket 160, the flange unit 150c, and the conductive tape 170, may be disposed along sides of the chassis 150 and the PDP 130 to seal emission of EMI therefrom.

### EXAMPLES

Two plasma display apparatuses according to embodiments of the present invention were formed and evaluated in terms of emission of electromagnetic waves outside the plasma display apparatuses. The first plasma display apparatus, i.e., Example 1, was formed according to the embodiment illustrated in FIG. 5, i.e., a plasma display apparatus including a flange unit directly attached to the front cover. The second plasma display apparatus, i.e., Example 2, was formed according to the embodiment illustrated in FIGS. 1-3, i.e., a plasma display apparatus including a flange unit including a continuous conductive gasket providing a reinforced surface grounding between the front cover and the chassis and a conductive tape 170.

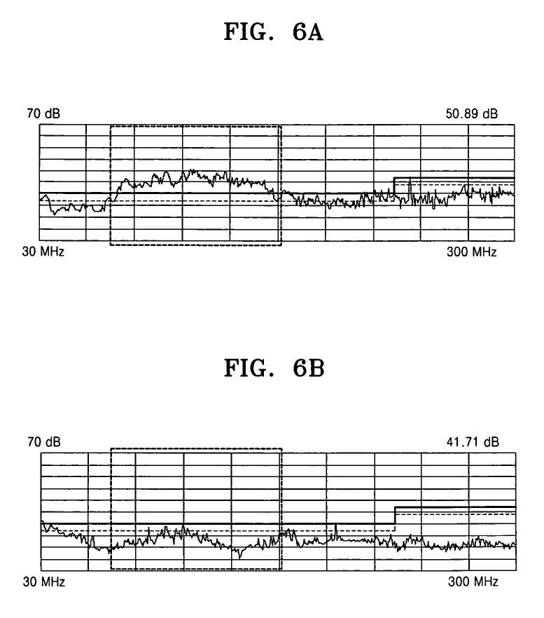

Electromagnetic waves in a frequency band of about 30 MHz to about 300 MHz in each of the two plasma display apparatuses were measured. Results are reported in Table 1 below and in FIGS. 6A-6B.

TABLE 1

| | | Valueₘₐₓ at overall |
|---|---|---|
| | Valueₘₐₓ at Low Frequency | Frequency |
| Example 1 | 50.89 dB (at 115.725 MHz) | 50.89 dB (at 115.725 MHz) |
| Example 2 | 39.29 dB (at 111.000 MHz) | 41.71 dB (at 197.400 MHz) |

As can be seen in Table 1 above, intensity of the electromagnetic waves is minimized. In particular, in the low frequency band, an electromagnetic wave of a maximum of 50.89 dB was measured at a frequency of 115.725 MHz in Example 1, and an electromagnetic wave of a maximum of 39.29 dB was measured at a frequency of 110.000 MHz in Example 2. In the overall frequency range of about 30 MHz to about 300 MHz, an electromagnetic wave of a maximum of 50.89 dB was measured at a frequency of 115.725 MHz in Example 1, and an electromagnetic wave of a maximum of 41.71 dB was measured at a frequency of 197.400 MHz in Example 2. A level of electromagnetic waves in Example 2 was lower than in Example 1, e.g., at a low frequency band of about 75 MHz to about 180 MHz, as indicated by the dotted boxes in FIGS. 6A-6B.

According to embodiments of the present invention, grounding gaps (voids) between the flange unit 150c of the chassis 150 and the front case 191 may be substantially minimized by the conductive gasket 160 and the conductive tape 170, and thus, the electromagnetic wave leaking through the gaps can be substantially blocked. Electromagnetic waves captured in the flange unit 150c may be smoothly drained through the front case 191 that may be closely connected to the conductive gasket 160.

As described above, in a plasma display apparatus according to embodiments of the present invention, leakage of electromagnetic waves may be structurally removed by shielding a PDP, which is a generating source of electromagnetic waves, from the outside through a surface grounding between a chassis and a case. In particular, in order to remove gaps that may be formed during a manufacturing process, a conductive gasket may be interposed between the chassis and the case, so surface grounding portions may be sealed using a conductive tape, thereby further increasing the electromagnetic wave shielding function of the plasma display apparatus.

Exemplary embodiments of the present invention have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. A plasma display apparatus, comprising:
a front case coupled to a rear case, the front and rear cases facing each other;
a plasma display panel between the front and rear cases; and
a chassis attached to the front case, the chassis being between the plasma display panel and the rear case, the chassis including,
a base unit parallel to the plasma display panel;
at least one flange unit on the front case, the flange being parallel to the base unit and spaced apart from the base unit, and
at least one shielding unit connecting the base unit with the flange unit, the shielding unit covering sides of the plasma display panel.

2. The plasma display apparatus as claimed in claim 1, wherein the shielding unit of the chassis is bent with respect to the base unit, and the flange unit of the chassis is bent with respect to the shielding unit.

3. The plasma display apparatus as claimed in claim 1, wherein the front case and the flange unit have a substantially planar contact surface.

4. The plasma display apparatus as claimed in claim 3, wherein the flange unit surrounds the base unit of the chassis.

5. The plasma display apparatus as claimed in claim 4, wherein the shielding unit covers all sides of the plasma display panel.

6. The plasma display apparatus as claimed in claim 3, wherein the front case and the flange unit are in direct contact with each other.

7. The plasma display apparatus as claimed in claim 1, further including a conductive gasket between the front case and the flange unit.

8. The plasma display apparatus as claimed in claim 7, wherein the conductive gasket includes flexible material.

9. The plasma display apparatus as claimed in claim 8, wherein the conductive gasket includes sponge-EMI.

10. The plasma display apparatus as claimed in claim 7, wherein the conductive gasket includes a plurality of portions spaced apart from each other along the flange unit.

11. The plasma display apparatus as claimed in claim 7, wherein the conductive gasket is continuous along the flange unit.

12. The plasma display apparatus as claimed in claim 7, further comprising screws configured to couple the front case, the conductive gasket, and the flange unit.

13. The plasma display apparatus as claimed in claim 1, further comprising a conductive tape across the front case and the flange unit.

14. The plasma display apparatus as claimed in claim 1, wherein the conductive tape overlaps at least one surface of the flange unit.

15. The plasma display apparatus as claimed in claim 1, wherein the front case includes a conductive material.

16. The plasma display apparatus as claimed in claim 1, further comprising a filter on the plasma display panel, the plasma display panel being between the filter and the chassis.

17. The plasma display apparatus as claimed in claim 16, wherein the filter includes an EMI shielding layer.

18. The plasma display apparatus as claimed in claim 16, further comprising a flexible grounding member between the filter and the front case.

19. The plasma display apparatus as claimed in claim 16, wherein the filter is between the plasma display panel and the front case, the plasma display panel being enclosed by an electromagnetic interference (EMI) shielding loop including at least the filter, the chassis, and the front case.

20. The plasma display apparatus as claimed in claim 1, further comprising at least one double-sided tape and a thermal conductive medium between the plasma display panel and the base unit of the chassis.
